(19) United States
(12) Patent Application Publication
(10) Pub. No.: US 2013/0042856 A1
(43) Pub. Date: Feb. 21, 2013

(54) Solar Energy Positioning System Using Cable Drives and Two Axis Pivot

(71) Applicants: Jon Switkes, San Jose, CA (US); Ross Koningstein, Atherton, CA (US); John S. Fitch, Los Altos, CA (US); Tamsyn Peronel Waterhouse, San Francisco, CA (US); Jung Shin Gwon, Santa Cruz, CA (US)

(72) Inventors: Jon Switkes, San Jose, CA (US); Ross Koningstein, Atherton, CA (US); John S. Fitch, Los Altos, CA (US); Tamsyn Peronel Waterhouse, San Francisco, CA (US); Timothy P. Allen, Santa Cruz, CA (US)

(73) Assignee: Google Inc., Mountain View, CA (US)

(21) Appl. No.: 13/211,431

(22) Filed: Aug. 17, 2011

(51) Int. Cl. F24J 2/52; G02B 7/198

(52) U.S. Cl. 126/606; 359/876

(57) ABSTRACT

A system for positioning a heliostat mirror or a solar collector includes a support structure, a pivot mechanism adapted to pivot the heliostat mirror or solar collector about a first generally horizontal axis and about a second axis generally perpendicular to the first axis, the pivot mechanism is attached to a rear side of the heliostat mirror or solar collector and attached to the support structure. The system also includes a first cable drive actuator having a first motor, driving a first cable spool, and a first cable attached at a proximal end to the first cable spool and attached at a distal end to the heliostat mirror or solar collector, and a second cable drive actuator having a second motor driving a second cable spool, and a second cable attached at a proximal end to the second cable spool and attached to the heliostat mirror or solar collector.

### TECHNICAL FIELD

This disclosure relates to systems and methods for solar energy management, more particularly positioning systems using cable drives and a two axis pivot.

### BACKGROUND

Solar energy management, collection, and use provide usable energy. In some applications, solar energy systems include solar collectors (sometimes referred to as “solar panels”). Solar collectors may include photovoltaic panels, solar thermal collectors, and biomass reactors. In some applications, solar energy systems may include multiple heliostats that reflect solar energy to a receiver. The receiver may then focus the reflected solar energy for a variety of uses. In some instances, heliostats are tracking mirrors, which reflect and focus sunlight onto a distant target, such as the receiver.

For optimal operation, solar collectors and heliostats move precisely and maintain a precise aiming angle, even when acted upon by external forces. For instance, it may be desirable to maintain an angle of a beam of sunlight reflected by the heliostat to within +/−1 milliradian. Substantial wind forces on a planar object, such as solar collectors or a heliostat, may apply forces and torques which tend to knock the beam off-target. One source of mechanical failure of solar collectors and heliostats is the mechanical bending of the positioning drive system under wind loads.

### SUMMARY

In general, this document describes systems and methods for positioning solar collectors and reflectors through the use of cable drive systems to pivot the solar devices using a two axis pivot system.

In a first aspect, a system for positioning a heliostat mirror includes a heliostat mirror, a heliostat mirror support structure, a pivot mechanism adapted to pivot the heliostat mirror about a first generally horizontal axis and about a second axis generally perpendicular to the first axis and moving with rotation about the first axis, said pivot mechanism attached to a rear side of the heliostat mirror and attached to the heliostat mirror support structure. The system also includes a first cable drive actuator having a first motor, driving a first cable spool, and a first cable attached at a proximal end to the first cable spool and attached at a distal end to the heliostat mirror, and a second cable drive actuator having a second motor driving a second cable spool, and a second cable attached at a proximal end to the second cable spool and attached at a distal end to the heliostat mirror. In another implementation, the cable drive actuators may be mounted to the mirror rather that the heliostat support structure, such that the cable is attached at the proximal end to the cable spool and attached at the distal end to the heliostat support structure or a ground anchor device.

Implementations can include all, some, or none of the following features. The system can also include a controller operatively connected to the first cable drive actuator, said controller adapted to direct the first cable drive actuator to spool in the first cable to pivot the heliostat mirror about the second axis toward the first cable drive actuator a predetermined amount, and operatively connected to the second cable drive actuator and adapted to direct the second cable drive actuator to let out the second cable to allow the heliostat mirror to pivot toward the first cable drive actuator. The system can also include a controller operatively connected to the first cable drive actuator, said controller adapted to direct the first cable drive actuator to spool in the first cable to pivot the heliostat mirror about the first axis toward the first cable drive actuator a predetermined amount, and operatively connected to the second cable drive actuator and adapted to direct the second cable drive actuator to let out the second cable to allow the heliostat mirror to pivot toward the first cable drive actuator. The system can also include a controller operatively connected to the first cable drive actuator, said controller adapted to direct the first cable drive actuator to spool in the first cable to pivot the heliostat mirror about the first axis and to pivot the heliostat mirror about the second axis toward the first cable drive actuator a predetermined amount, and operatively connected to the second cable drive actuator and adapted to direct the second cable drive actuator to let out the second cable to allow the heliostat mirror to pivot toward the first cable drive actuator. The support structure can include a first downwardly disposed leg positioned proximal to the rear side of the heliostat mirror, a second downwardly disposed leg positioned rearward from the first leg, a third downwardly disposed leg positioned rearward from the first leg, said legs joined at an upper end in an apex. The first cable drive actuator can be mounted on the second leg, and the second cable drive actuator is mounted on the third leg. The first cable attachment bracket can be mounted on a rear side of the heliostat mirror proximal to a first side edge and a second cable attachment bracket is mounted on the rear side of the heliostat mirror proximal to a second side edge. The pivot mechanism can be attached to a rear side of the heliostat mirror above the center of gravity of the heliostat mirror and the system can be adapted to maintain a tension on the first and second cables by gravitational force seeking to pivot the heliostat mirror downward about the horizontal axis. At least one counter weight can be connected to the heliostat mirror, and said counter weight can be adapted to maintain a tension on the first and second cables by gravitational force seeking to pivot the heliostat mirror downward about the horizontal axis. At least one biasing member can be connected to the heliostat mirror and the support structure. The biasing member can be adapted to maintain tension on the first and second cables. The pivot mechanism can be a universal joint. The support structure can also include a support brace disposed between and connected to the second leg and third leg, and the first cable drive actuator can be mounted on a portion of the support brace of the support structure proximal to the second downwardly disposed leg and the second cable drive mechanism can be mounted on a portion of the support brace proximal to the third downwardly disposed leg. The system can also include a third cable drive actuator mounted on the support structure, said third cable drive actuator having a third motor, driving a third cable spool, and a third cable attached at a proximal end to the third cable spool and attached at a distal end to the heliostat mirror, and a first tension line sensor on the first cable operatively connected to the controller, and a second tension line sensor on the second cable operatively connected to the controller, said controller adapted to receive tension information from the first and second tension line sensors and to provide instructions to the third cable drive actuator to either let out the third cable or spool in the third cable to adjust the tension in the first and second cables attached to the first and second cable drive actuators. At least one of the first and second motors of the first and second cable drive actuators can be adapted to receive an instruction from the controller to stop, start, rotate a motor torque output member in a clockwise direction by a controlled amount and at a specified speed, and rotate the motor torque output member in a counterclockwise direction by a controlled amount and at a specified speed. At least one of the first and second cable drive actuators can further include a gear mechanism having an input connected to a motor torque output member and a rotatable output shaft connected to the cable spool, said gear mechanism adapted to reduce the rotational speed of the rotatable output shaft of the gear mechanism to less than a rotational speed of the motor torque output and increase the torque output in the rotatable output shaft of the gear mechanism. The system can include a stop chain attached at a first end to the support structure and at a second end to a rear side of the heliostat mirror, said stop chain having a predetermined length sufficient to allow the heliostat mirror to pivot about the first axis to a maximum position that is substantially horizontal.

In a second aspect, a method for positioning a heliostat mirror includes providing a heliostat mirror, said heliostat mirror pivotally mounted on a heliostat mirror support structure, providing a first cable drive actuator having a first motor, driving a first cable spool, and a first cable attached at a proximal end to the first cable spool and attached at a distal end to a rear side of the heliostat mirror, providing a second cable drive actuator having a second motor driving a second cable spool, and a second cable attached at a proximal end to the second cable spool and attached at a distal end to the heliostat mirror, providing a pivot mechanism adapted to pivot the heliostat mirror about a first generally horizontal axis and about a second axis generally perpendicular to the first axis, said pivot mechanism attached to a rear side of the heliostat mirror and attached to the heliostat mirror support structure, providing a controller operatively connected to the first cable drive actuator and operatively connected to the second cable drive actuator, sending one or more signals to one or more cable drive actuators. To pivot the heliostat mirror about the first generally horizontal axis, the two cable drive actuators are sent signals to move in conjunction. That is, they are both sent signals to reel in cable at the same time or let out cable at the same time. To pivot the heliostat mirror primarily about the second axis that is perpendicular to the first axis, the two actuators are sent signals to move in opposition. That is, one cable drive actuator is sent a signal to reel in cable while the other cable drive actuator is sent a signal to let out cable. Sending a signal to only one cable drive actuator would pivot the heliostat mirror to varying degrees about both the first axis and second axis.

Implementations can include any, all, or none of the following features. The method can also include rotating the heliostat mirror upward and downward about a generally horizontal axis (sometimes referred to as “pitch”) and rotating to the left or right about a second axis generally perpendicular to the horizontal axis (sometimes referred to as “roll”). The method can also include providing a third cable drive actuator mounted on the support structure, said third cable drive actuator having a third motor, driving a third cable spool, and a third cable attached at a proximal end to the third cable spool and attached at a distal end to the rear side of the heliostat mirror, providing a first tension line sensor on the first cable operatively connected to the controller, and a second tension line sensor on the second cable operatively connected to the controller, receiving in the controller tension information from the first and second tension line sensors, providing instructions to the third cable drive actuator to either let out the third cable or to spool in the third cable to adjust the tension in the first and second cables attached to the first and second cable drive actuators. The method includes increasing the torque force applied to the heliostat mirror by connecting the first cable to a rear side of the heliostat mirror proximal to a first side edge and connecting the second cable to the rear side of the heliostat mirror proximal to a second side edge. The method can also include attaching the heliostat mirror to the support structure with a two-axis pivot attached to the rear side of the heliostat mirror above the center of gravity of the heliostat mirror, thereby maintaining a tension on the first and second cables by gravitational force acting to pivot the heliostat mirror downward. The method can also include applying tension to the cables by connecting a counter weight to the heliostat mirror, said counter weight thereby maintaining a tension on the first and second cables by gravitational force seeking to pivot the heliostat mirror downward about the horizontal axis. The method can also include applying tension to the first and second cables by connecting at least one biasing member (spring) to the heliostat mirror and to the support structure, said biasing member thereby maintaining tension on the first and second cables. The method can also include sending a signal from the controller to at least one of the first and second motors of the first and second cable drive actuators to stop, start, rotate a motor torque output member in a clockwise direction, and rotate the motor torque output member in a counterclockwise direction.

The preceding aspects have been described in terms of manipulating a heliostat mirror, although in other aspects the previously described system and methods can be used to manipulate solar collectors (e.g., photovoltaic panels, solar thermal collectors, biomass reactors). The systems and techniques described here may provide one or more of the following advantages. First, a system can provide an effective way to orient solar collectors and reflectors. Second, the system can provide a relatively simpler and more economical positioning mechanism than other positioning mechanisms currently in use. Third, the system can provide increased mechanical reliability compared to other positioning systems currently in use. Fourth, the pitch/roll system kinematics can make accelerometer tracking and photogrammetric tracking work better because the second axis is not generally vertical.

The details of one or more implementations are set forth in the accompanying drawings and the description below. Other features and advantages will be apparent from the description and drawings, and from the claims.

### DESCRIPTION OF DRAWINGS

FIG. 1 illustrates an example embodiment of a solar energy positioning system.

FIG. 2 illustrates a cutaway view of an example embodiment of a cable drive actuator.

FIG. 3 is a flow chart that shows an example of a process for positioning a solar energy member.

FIG. 4 is a schematic diagram of an example of a generic computer system.

### DETAILED DESCRIPTION

The present disclosure describes embodiments of a solar energy assembly. In one embodiment, a solar energy assembly according to the present disclosure may include a tubular pyramidal support structure with a substantially vertical structural member secured to a terranean surface by a footing structure. In other embodiments a single post or other mounting structure may be used. A solar energy member, such as a heliostat mirror or solar collector such as a photovoltaic cell, may be mounted near an apex of the support structure for two axis rotational and pivotal movement about a point near the orthogonal midpoint of the solar energy member. In some embodiments, multiple cables are secured at first ends of the cables to a portion of the solar energy member above the pivot point and at second ends of the cables to cable drive actuators (e.g., winches) mounted on the support structure or ground. It will be understood that in alternative embodiments, the first end of the cable may be attached to the support structure or ground and the drive motors may be attached to the solar energy member. In some aspects, the support structure and cables may limit angular deflection of the solar energy member due to, for example, gravitational forces or a wind load on the solar energy assembly. It will be understood that in alternative embodiments hydraulic pistons or screw actuators may be used instead of cable drives and cables.

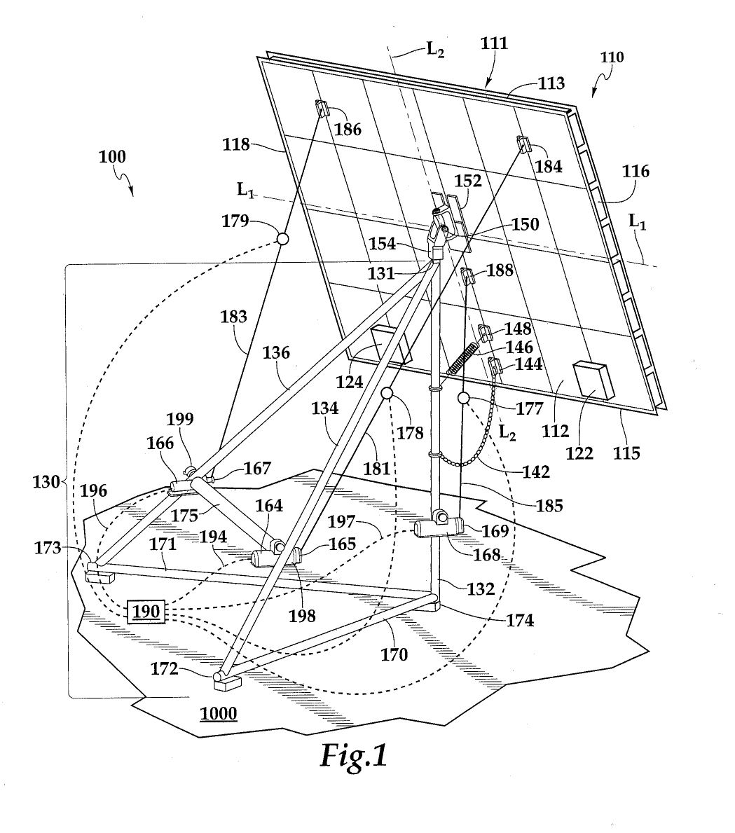

FIG. 1 illustrates an example embodiment of a solar energy system 100. The system 100 includes a solar energy member 110 that includes a front 111, rear side 112 having a top edge 113, a bottom edge 115 and a side edge 116 and a side edge 118. In some implementations, the solar energy member 110 can be a heliostat, or any other appropriate flat or curved mirror or other reflective front surface 111. In some implementations, the solar energy member 110 can be a solar collector, such as a photovoltaic (PV) panel, a photochemical energy panel, a solar thermal collector, or any other appropriate solar energy collection assembly.

The system 100 also includes a support structure 130 that rests on a ground surface 1000. In one implementation, the support structure 130 includes a support leg 132, a support leg 134, and a support leg 136. The support legs 132-136 are arranged in a tripod configuration in which the upper ends of the support legs 132-136 substantially converge at an apex 131. The lower ends of the support legs 132-136 are coupled to a longitudinal support member 170 and to a longitudinal support member 171. The support leg 134 is coupled to the longitudinal support member 170 at a coupling 172. The support leg 136 is coupled to the longitudinal support member 171 at a coupling 173. The support leg 132 is coupled to the longitudinal support members 170 and 171 at a coupling 174. A longitudinal support member 175 couples the support legs 134 and 136. One end of the longitudinal support member 175 is coupled to the support leg 134 at a coupling 198, and the opposite end of the longitudinal support member 175 is coupled to the longitudinal support member 136 at a coupling 199. In other implementations, the mounting structure (not shown) can be a single post having outwardly disposed arms on which a respective cable drive actuator is mounted. It will be understood that the cable drive actuator or other actuator assemblies may be mounted on the ground or independent structural members and that for operation of the present disclosure it is not necessary that the cable drive actuators or other actuator assemblies be mounted on the support structure. It will be understood that in another implementation, the cable drive actuators may be mounted to the mirror rather than the heliostat mounting structure, such that the cable is attached at the proximal end to the cable spool and attached at the distal end to the heliostat mounting structure or a ground anchor device.

The solar energy member 110 is coupled to the support structure 130 by a pivot mechanism 150. The pivot mechanism 150 is adapted to pivot the solar energy member 110 about a generally horizontal axis L1 and about an axis L2 that is generally perpendicular to the axis L1. In some implementations, the pivot mechanism 150 can be a universal joint (U-joint), and in particular a Cardan type U-joint may be used in some implementations. For example, a U-joint pivot mechanism may allow the solar energy member 110 to pitch and roll about the apex 131, but may prevent the solar energy member from yawing at the apex about a vertical axis 131. The pivot mechanism 150 includes a mounting member 152 attached to the rear side 112 of the solar energy member 110 and a mounting member 154 attached to the support structure 130. In another implementation (not shown) the pivot assembly can be a rotatable sleeve disposed over a mounting post. The rotatable sleeve allows rotation about a first axis. A single direction pivot may be mounted on the distal end to the rotatable sleeve and connected to the solar energy member. The single direction pivot permits rotation in an axis perpendicular to the first axis.

A pair of cable drive actuators 164 and 166 is provided to move and position the solar energy member 110 about the pivot mechanism 150. In some implementations, the cable drive actuators 164 and 166 may be cable winches. The cable drive actuator 164 is mounted on the support leg 134 and includes a motor 161. In some implementations, the cable drive actuators 164 and 166 can be mounted on the lateral support member 175. The motor 161 drives a cable spool 165, and a cable 181 is attached at a proximal end to the cable spool 165. The cable 181 is attached at a distal end to a cable attachment bracket 184 mounted on the rear side 112 of the solar energy member 110 proximal to the side edge 116. The cable drive actuator 166 is mounted on the support leg 136 and includes a motor 161 driving a cable spool 167. A cable 183 is attached at a proximal end to the cable spool 167, and is attached at a distal end to cable attachment bracket 186 on the rear side 112 of the solar energy member 110 proximal to the side edge 118.

In some implementations, the mounting member 152 of pivot mechanism 150 can be attached to the rear side 112 of the solar energy member 110 above the center of gravity of the solar energy member 110 and the system 100 can be adapted to maintain a tension on the cables 181 and 183 by gravitational force acting to pivot the solar energy member 110 downward about the axis L1. For example, by placing the mounting member 152 above the center of gravity, a greater portion of the solar energy member's 110 mass can be located below the axis L1, and gravitational forces may act to draw the solar energy member 110 into fully constrained alignment against the pull of the cables 181 and 183.

In some implementations, one or more counter weights 122, 124 can be connected to the solar energy member 110. For example, the counter weights 122, 124 can be adapted to maintain a tension on the cables 181 and 183 by gravitational force seeking to pivot the solar energy member 110 downward about the axis L1. In some implementations, at least one biasing member 146 (e.g., a spring) can be connected to the solar energy member 110 by a mounting bracket 148 and to the support leg 132. For example, the biasing member 146 can be adapted to maintain tension on the cables 181 and 183.

A controller 190 is operatively connected to the cable drive actuators 164 and 166 by a communication bus 194 and a communication bus 196, or alternatively by wireless communication. The controller 190 is adapted to direct the cable drive actuator 166 to spool in cable 183 a predetermined amount, and the controller 190 is also adapted to direct the cable drive actuator 164 to let out cable 181 a predetermined amount to allow the solar energy member 110 to pivot substantially about the axis L2 toward the cable drive actuator 166 (e.g., to roll leftward).

The controller 190 is adapted to direct the cable drive actuator 164 to spool in cable 181 a predetermined amount, and the controller 190 is also adapted to direct the cable drive actuator 166 to let out cable 183 a predetermined amount to allow the solar energy member 110 to pivot substantially about the axis L2 toward the cable drive actuator 164 (e.g., to roll rightward).

The controller 190 is adapted to direct the cable drive actuators 164 and 166 to spool in the cables 181 and 183 a predetermined amount to allow the solar energy member 110 to pivot substantially about the axis L1 toward the cable drive actuators 164 and 166 (e.g., to pitch upward). Likewise, the controller 190 is adapted to direct the cable drive actuators 164 and 166 to let out the cables 181 and 183 a predetermined amount to allow the solar energy member 110 to pivot substantially about the axis L1 away from the cable drive actuators 164 and 166 (e.g., to pitch downward).

In use, by retracting or extending the cables 181 and 183 by substantially equal amounts, the solar energy member 110 can be pitched about the axis L1, and by extending one of the cables 181 or 183 while simultaneously retracting the other cable by substantially the same amount, the solar energy member 110 can be rolled about the axis L2. The controller 190 is also adapted to direct the cable drive actuators 164 and 166 to spool in or let out the cables 181 and 183 in differing predetermined amounts. For example, the controller 190 can be operatively connected to the cable drive actuator 164 and can direct the cable drive actuator 164 to spool in the cable 181 to pivot the solar energy module 110 about the axis L1 and to pivot about the axis L2 toward the cable drive actuator 164 a predetermined amount, and can be operatively connected to the cable drive actuator 166 to direct the cable drive actuator 166 to let out the cable 183 to allow the solar energy member 110 to pivot toward the cable drive actuator 164. To pivot the heliostat mirror about the first generally horizontal axis L1, the two cable drive actuators 164 and 166 rotate in conjunction. That is, they reel in cable at the same time or let out cable at the same time. To pivot the heliostat mirror primarily about the second axis L2 that is perpendicular to the first axis, the two cable drive actuators 164 and 166 rotate in opposition. That is, one cable drive actuator reels in cable while the other cable drive actuator lets out cable. Actuation on only one cable drive actuator pivots the heliostat mirror about both the first axis and second axis.

A tension line sensor 178 is mounted on the cable 181, and a tension line sensor 179 is mounted on the cable 183. The tension line sensors 178, 179 are operatively coupled to the controller 190, such that the controller 190 is able to receive signals conveying information that describes the amount of tension on the cables 181 and 183. For example, during movement, sensed tensions on the cables 181 and 183 that are in excess of a predetermined limit may indicate mechanical interference (e.g., something has fallen against the solar energy member 110 so as to impede its movement) or mechanical failure (e.g., the pivot mechanism 150 is in need of lubrication or other maintenance). In another example, varying or excessive tensions sensed while the solar energy member 110 is supposed to be stationary may indicate that the solar energy member 110 is being subjected to strong winds.

In some implementations, a third cable drive actuator 168 can be mounted on the support leg 132 and communicatively coupled to the controller 190 by a communication bus 197. For example, the cable drive actuator 168 can have a motor 161 driving a cable spool 169, and cable 185 attached at a proximal end to the cable spool 169 and attached at a distal end to a cable attachment bracket 188 mounted on the rear side 118 of the solar energy member 110. A tension line sensor 177 can be mounted on the cable 185 and communicatively coupled to the controller 190 to provide information about the amount of tension on the cable 185. In some implementations, the tension line sensors 177, 178 and 179 can provide information about the amount of tension on the cables 185, 181 and 183, and the controller 190 can be adapted to receive the tension information from the tension sensors 177, 178, 179 and provide instructions to the cable drive actuator 168 to either let out the cable 185 or spool in the cable 185 to adjust the tension in the cables 181, 183 attached to the cable drive actuators 165, 166.

In some implementations, a stop chain 142 can be attached at a first end to the support leg 132 and at a second end to a mounting bracket 144 disposed on the back of the solar energy member 110. In some implementations, the stop chain 142 can also act as counter weights 122 and/or 124. The stop chain 142 can have a predetermined length sufficient to allow the solar energy member 110 to pivot about the axis L1 to a maximum position that is substantially planar to the ground surface 1000. For example, in the presence of potentially damaging high winds, the solar energy member 110 may be positioned in the described horizontal position so as to present a substantially minimal cross-section to the wind.

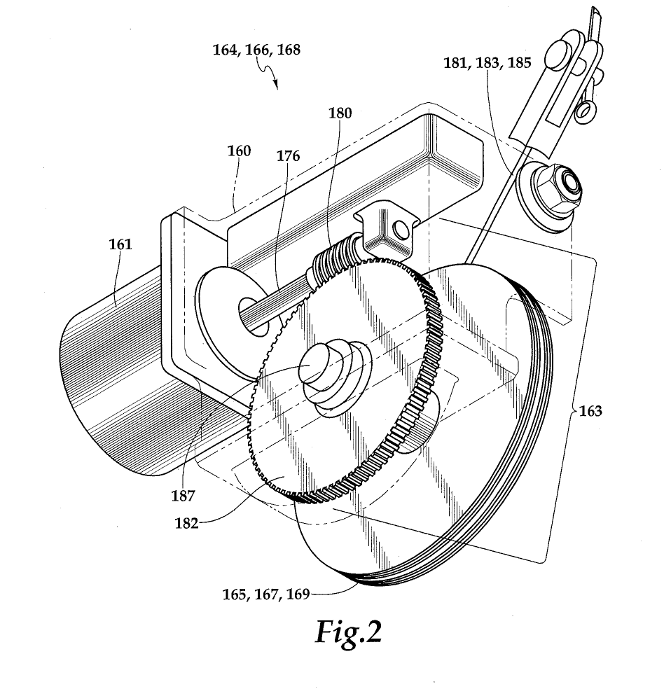

FIG. 2 illustrates a cutaway view of an example embodiment of a cable drive actuator. In some embodiments, the illustrated cable drive actuator can be the cable drive actuator 164, 166, or 168 of FIG. 1. The cable drive actuators 165, 166, 168 include a case 160, a motor 161, a gear drive mechanism 163 and a spool 165, 167, 169.

The motor 161 is operatively coupled to the controller 190. The motor of 161 is adapted to receive an instruction from the controller 190 to stop, start, and rotate a motor torque output member 176 (e.g., output shaft) in a clockwise direction and rotate the motor torque output member 176 in a counterclockwise direction at a controlled speed and to a controlled position.

The motor 161 is coupled to the cable spool 165, 167 and 169 by the gear drive mechanism 163. In the illustrated example, the gear drive mechanism 163 is a worm gear drive mechanism. The motor torque output member 176 acts as a worm shaft, driving a worm 180 formed about the distal end of the motor torque output member 176. The worm 180 is a helical gear that intermeshes with teeth formed in a worm wheel 182. The worm wheel 182 is coupled to the spool 165, 167, 169 by a shared axle 187. In use, the motor 161 drives the torque output member 176, which drives the worm wheel 182, and in turn drives the spool 165, 167, 169.

A section of the proximal end of the cable 181, 183, or 185 is wound around the cable spool 165, 167, 169. As the spool 165, 167, 169 is controllably rotated clockwise and counterclockwise, the cable 181, 183, or 185 is controllably gathered and released from the cable drive actuator 164, 166, or 168. By controllably gathering and releasing the cables 181, 183, and 185 through the cable drive actuators 164, 166, and 168, the controller 190 can control the motion and position of the solar energy member 110 (e.g., to align a photovoltaic panel with the sun, or to aim solar energy reflected off a heliostat mirror).

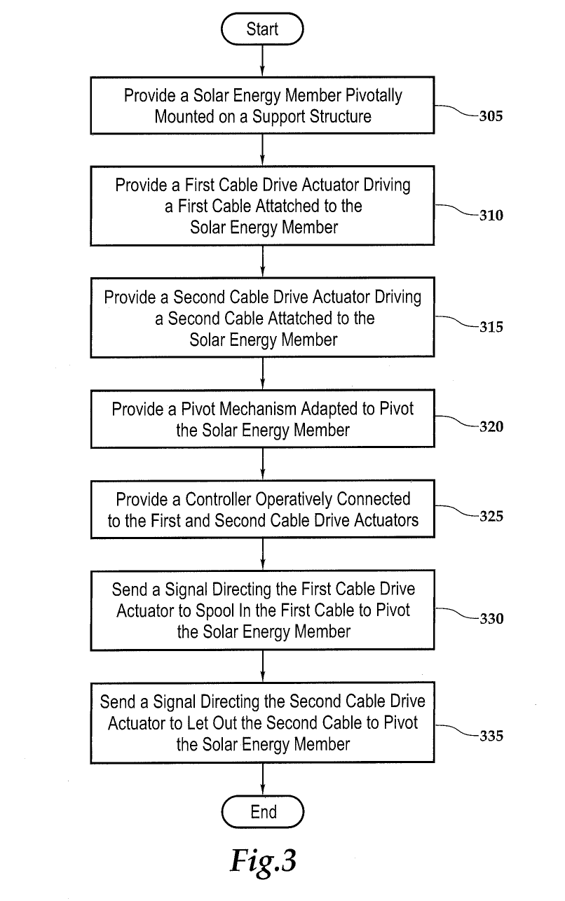

FIG. 3 is a flow chart that shows an example of a process 300 for positioning a solar energy member, such as the solar energy member 110 of FIG. 1. In some implementations, the process 300 can be used to position a solar energy member such as a heliostat, or any other appropriate solar energy reflector. In some implementations, the process 300 can be used to position a solar energy member such as a solar panel, a photovoltaic panel, a photochemical reactor panel, a solar thermal panel, or any other appropriate solar energy collector.

The process begins at step 305 by providing a solar energy member including a front, and a rear side having a top edge, a bottom edge, a first side edge, and a second side edge; the solar energy member being pivotally mounted on a support structure. For example, the solar energy member 110 can be mounted upon the support structure 130 by the pivot mechanism 150.

At step 310, a first cable drive actuator is provided. The first cable drive actuator includes a first motor driving a first cable spool and a first cable attached at a proximal end to the first cable spool and attached at a distal end to a first cable attachment bracket mounted on the rear side of the solar energy member. For example, the cable drive actuator 164 includes the motor 161, and drives the cable spool 165 and the cable 181 attached at a proximal end to the cable spool 165 and attached at a distal end to the cable attachment bracket 184 mounted on the rear side 112 of the solar energy member 110.

At step 315, a second cable drive actuator is provided. The second cable drive actuator includes a second motor driving a second cable spool and a second cable attached at a proximal end to the second cable spool and attached at a distal end to a second cable attachment bracket mounted on the rear side of the solar energy member. For example, the cable drive actuator 166 includes the motor 161, and drives the cable spool 167 and the cable 183 attached at a proximal end to the cable spool 163 and attached at a distal end to the cable attachment bracket 186 mounted on the rear side 112 of the solar energy member 110.

At step 320, a pivot mechanism is provided. The pivot mechanism is adapted to pivot the solar energy member about a first generally horizontal axis and about a second axis generally perpendicular to the first axis. The pivot mechanism has a first mounting member 154 attached to the rear side of the solar energy member and a second mounting member attached to the support structure. For example, the pivot mechanism 150 is adapted to pivot the solar energy member 110 about the axis L1, which is generally horizontal, and about the axis L2, which is generally perpendicular to the first axis. The pivot mechanism 150 includes the mounting member 152 attached to the rear side 114 of the solar energy member and the mounting member 154 attached to the support structure 130.

At step 325, a controller is provided and is operatively connected to the first cable drive actuator and to the second cable drive actuator. For example, the controller 190 is operatively connected to the cable drive actuator 164 and to the cable drive actuator 166.

At step 330, the controller sends a signal to the first cable drive actuator. The signal directs the first cable drive actuator to spool in the first cable to pivot the solar energy member about the first axis and about the second axis toward the first cable drive actuator a predetermined amount. For example, the controller 190 sends a signal to the cable drive actuator 164 to direct the cable drive actuator 164 to spool in the cable 181 to pivot the solar energy member 110 about the axis L1 and about the axis L2 toward the cable drive actuator 164 a predetermined amount and at a predetermined rate.

At step 335, the controller sends a signal to the second cable drive actuator. The signal directs the second cable drive actuator to let out the second cable to pivot the solar energy member about the first axis and about the second axis toward the first cable drive actuator a predetermined amount. For example, the controller 190 sends a signal to the cable drive actuator 166 to direct the cable drive actuator 166 to let out the cable 183 to pivot the solar energy member 110 about the axis L1 and about the axis L2 toward the cable drive actuator 164 a predetermined amount at a predetermined rate. In summary, the controller may send one or more signals to one or more cable drive actuators. To pivot the heliostat mirror about the first generally horizontal axis, the two cable drive actuators are sent signals to move in conjunction. That is, they are both sent signals to reel in cable at the same time or let out cable at the same time. To pivot the heliostat mirror primarily about the second axis that is perpendicular to the first axis, the two actuators are sent signals to move in opposition. That is, one cable drive actuator is sent a signal to reel in cable while the other cable drive actuator is sent a signal to let out cable. Sending a signal to only one cable drive actuator would pivot the heliostat mirror about both the first axis and second axis.

In some implementations, the process 300 can be used to rotate the solar energy member upward and downward about a horizontal axis and rotating to the left or right about an axis generally perpendicular to the horizontal axis. For example, the process 300 can be used to pitch the solar energy member 110 about the axis L1, which is substantially horizontal, and roll about the axis L2, which is substantially perpendicular to the axis L1.

In some implementations, the process 300 can include steps for providing a third cable drive actuator mounted on a first support leg, said third cable drive actuator having a third motor driving a third cable spool, and a third cable attached at a proximal end to the third cable spool and attached at a distal end to a third cable attachment bracket mounted on the rear side of the solar energy member; providing a first tension line sensor on the first cable operatively connected to the controller and a second tension line sensor operatively connected to the controller; receiving in the controller tension information from the first and second tension sensors; and providing instructions to the third cable drive actuator to either let out cable or spool in cable to adjust the tension in the cables attached to the first and second cable drive actuators. For example, the cable drive actuator 168 can be mounted on the support leg 132 to gather and release the cable 185 which is connected to the solar energy member 110 at the cable attachment bracket 188. The tension line sensors 177 and 178 are mounted on the cables 181 and 183 to provide tension information to the controller 190. The controller 190 can provide instructions to the cable drive actuator 168 to either let out the cable 185 or spool in the cable 185 to adjust the tension in the cables 181, 183 attached to the cable drive actuators 164, 166.

In some implementations, the process 300 can include a step of increasing the torque force applied to the solar energy member by mounting the first cable attachment bracket on the rear side of the solar energy member proximal to the first side edge and mounting the second cable attachment bracket on the rear side of the solar energy member proximal to the second side edge. For example, the cable attachment bracket 184 can be mounted on the rear side 112 of the solar energy member 110 proximal to the side edge 116, and the cable attachment bracket 186 can be mounted on the rear side 112 proximal to the side edge 118.

In some implementations, the process 300 can include a step of attaching the solar energy member to the support structure with a two-axis pivot attached to the rear side of the solar energy member above the center of gravity of the solar energy member, thereby maintaining a tension on the first and second cables by gravitational force seeking to pivot the solar energy member downward about the horizontal axis. For example, the solar energy member 110 can be mounted to the support structure 130 by the pivot mechanism 150, which is affixed to the solar energy member 110 at a point above the center of gravity of the solar energy member 110.

In some implementations, the process 300 can include a step of applying tension to the first and second cables by connecting a counter weight to the solar energy member, said counter weight thereby maintaining a tension on the first and second cables by gravitational force seeking to pivot the solar energy member downward about the horizontal axis. For example, the counter weights 122 and 124 can be mounted near the bottom edge 115, such that the gravitational pull on the counter weights 122 and 124 tends to tilt the solar energy member 110 away from the direction of pull of the cables 181 and 183.

In some implementations, the process 300 can include a step of applying tension to the first and second cables by connecting at least one biasing member to the solar energy member and to the support structure, the said biasing member thereby maintaining tension on the first and second cables. For example, the bias member 146 can provide a spring force between the solar energy member 110 and the support leg 132. The spring force tends to act against the draw of the cables 181 and 183.

In some implementations, the process 300 can include a step of sending a signal from the controller to the motor of the first, second, or third cable drive actuators to stop, start, rotate a motor torque output member in a clockwise direction, and rotate the motor torque output member in a counterclockwise direction. For example, the controller 190 can send a signal to the motor 161 of the cable drive actuator 164 to cause the torque output member 176 to stop, start, rotate clockwise, and rotate counterclockwise.

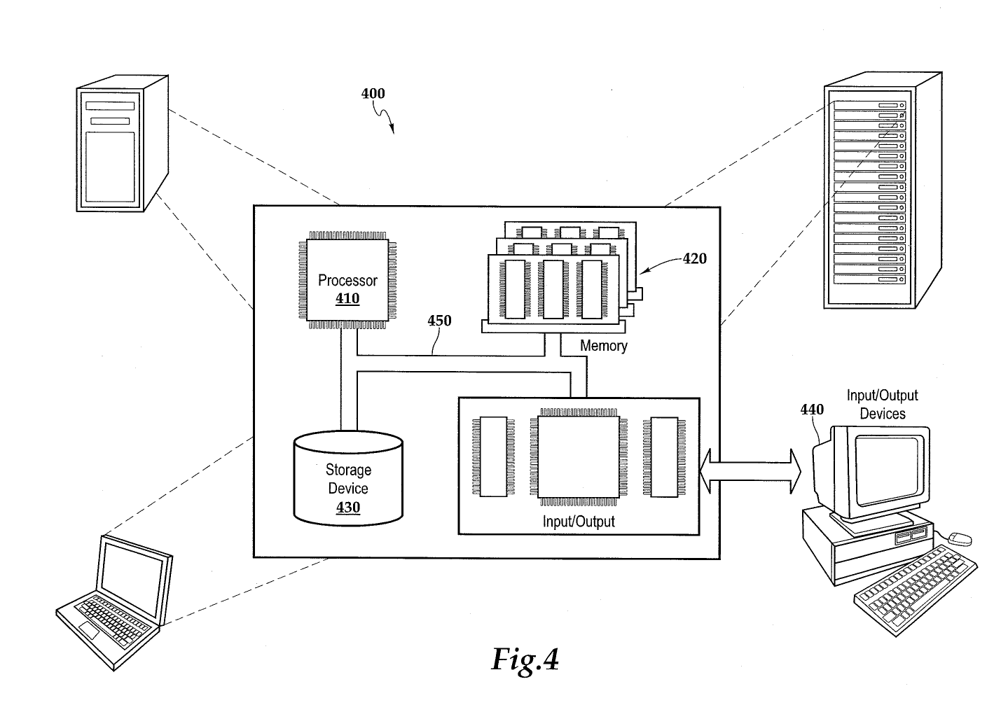

FIG. 4 is a schematic diagram of an example of a generic computer system 400. The system 400 can be used for the operations described in association with the method 300 according to one implementation. For example, the system 400 may be included in the controller 190, or in the cable drive actuators 164, 166, and 168.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files,; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system for positioning a heliostat mirror, said system comprising:
a heliostat mirror;
a heliostat mirror support structure;
a pivot mechanism adapted to pivot the heliostat mirror about a first generally horizontal axis and about a second axis generally perpendicular to the first axis, said pivot mechanism attached to a rear side of the heliostat mirror and attached to the heliostat mirror support structure;
a first cable drive actuator having a first motor, driving a first cable spool, and a first cable attached at a proximal end to the first cable spool and attached at a distal end to the heliostat mirror; and
a second cable drive actuator having a second motor driving a second cable spool, and a second cable attached at a proximal end to the second cable spool and attached at a distal end to the heliostat mirror.

2. The system of claim 1 further including a controller operatively connected to the first cable drive actuator and operatively connected to the second cable drive actuator, said controller adapted to direct the first and second cable drive actuators to move the mirror in pitch and roll.

3. The system of claim 2 wherein the cable drive actuators are adapted to both reel in cable at the same time or let out cable at the same time to pivot the heliostat mirror about the first generally horizontal axis.

4. The system of claim 2 wherein one cable drive actuator is adapted to reel in cable while the other cable drive actuator lets out cable to pivot the heliostat mirror primarily about the second axis.

5. The system of claim 2 wherein the first cable drive actuator is adapted to reel in or let out cable while the second cable drive actuator is not activated to pivot the heliostat mirror about both the first axis and second axis.

6. The system of claim 1 wherein the support structure comprises:
a first downwardly disposed leg positioned proximal to the rear side of the heliostat mirror;
a second downwardly disposed leg positioned rearward from the first leg;
a third downwardly disposed leg positioned rearward from the first leg, said legs joined at an upper end in an apex.

7. The system of claim 1 wherein a first cable attachment bracket is mounted on a rear side of the heliostat mirror proximal to a first side edge and a second cable attachment bracket is mounted on the rear side of the heliostat mirror proximal to a second side edge.

8. The system of claim 1 wherein the pivot mechanism is attached to a rear side of the heliostat mirror above the center of gravity of the heliostat mirror and the system is adapted to maintain a tension on the first and second cables and by gravitational force acting to pivot the heliostat mirror downward about the horizontal axis.

9. The system of claim 1 wherein the pivot mechanism is a universal joint.

10. The system of claim 6 further including:
a third cable drive actuator mounted on the support structure, said third cable drive actuator having a third motor, driving a third cable spool, and a third cable attached at a proximal end to the third cable spool and attached at a distal end to the heliostat mirror; and
a first tension line sensor on the first cable operatively connected to the controller, and a second tension line sensor on the second cable operatively connected to the controller; said controller adapted to receive tension information from the first and second tension line sensors and to provide instructions to the third cable drive actuator to either let out the third cable or spool in the third cable to adjust the tension in the first and second cables attached to the first and second cable drive actuators.

11. The system of claim 1 wherein at least one of the first and second motors of the first and second cable drive actuators is adapted to receive an instruction from the controller to stop, start, rotate a motor torque output member of the first motor in a clockwise direction, and rotate the motor torque output member of the second motor in a counterclockwise direction.

12. The system of claim 1 wherein at least one of the first and second cable drive actuators further includes a gear mechanism having an input connected to a motor torque output member and a rotatable output shaft connected to the cable spool, said gear mechanism adapted to reduce the rotational speed of the rotatable output shaft of the gear mechanism to less than a rotational speed of the motor torque output and increase the torque output in the rotatable output shaft of the gear mechanism.

13. A system for positioning a solar panel, said system comprising:
a solar panel;
a solar panel support structure;
a pivot mechanism adapted to pivot the solar panel about a first generally horizontal axis and about a second axis generally perpendicular to the first axis, said pivot mechanism attached to a rear side of the solar panel and attached to the solar panel support structure;
a first cable drive actuator having a first motor, driving a first cable spool, and a first cable attached at a proximal end to the first cable spool and attached at a distal end to the rear side of the solar panel; and
a second cable drive actuator having a second motor driving a second cable spool, and a second cable attached at a proximal end to the second cable spool and attached at a distal end mounted on the rear side of the solar panel.

14. The system of claim 13 further including a controller operatively connected to the first cable drive actuator and operatively connected to the second cable drive actuator, said controller adapted to direct the first and second cable drive actuators to move the solar panel in pitch and roll.

15. The system of claim 14 wherein the cable drive actuators are adapted to both reel in cable at the same time or let out cable at the same time to pivot the solar panel about the first generally horizontal axis.

16. The system of claim 14 wherein one cable drive actuator is adapted to reel in cable while the other cable drive actuator lets out cable to pivot the solar panel primarily about the second axis.

17. The system of claim 14 wherein the first cable drive actuator is adapted to reel in or let out cable while the second cable drive actuator is not activated to pivot the solar panel about both the first axis and second axis.

18. The system of claim 13 wherein the support structure comprises:
a first downwardly disposed leg positioned proximal to the rear side of the solar panel;
a second downwardly disposed leg positioned rearward from the first leg;
a third downwardly disposed leg positioned rearward from the first leg, said legs joined at an upper end in an apex.

19. The system of claim 13 wherein the first cable attachment bracket is mounted on a rear side of the solar panel proximal to a first side edge and the second cable attachment bracket is mounted on the rear side of the solar panel proximal to a second side edge.

20. The system of claim 13 wherein the pivot mechanism is attached to a rear side of the solar panel above the center of gravity of the solar panel and the system is adapted to maintain a tension on the first and second cables by gravitational force acting to pivot the solar panel downward about the horizontal axis.

21. The system of claim 13 wherein the pivot mechanism is a universal joint.

22. The system of claim 18 further including:
a third cable drive actuator mounted on the support structure, said third cable drive actuator having a third motor, driving a third cable spool, and a third cable attached at a proximal end to the third cable spool and attached at a distal end to the solar panel; and
a first tension line sensor on the first cable operatively connected to the controller, and a second tension line sensor on the second cable operatively connected to the controller; said controller adapted to receive tension information from the first and second tension line sensors and to provide instructions to the third cable drive actuator to either let out the third cable or spool in the third cable to adjust the tension in the first and second cables attached to the first and second cable drive actuators.

23. The system of claim 13 wherein at least one of the first and second motors of the first and second cable drive actuators is adapted to receive an instruction from the controller to stop, start, rotate a motor torque output member in a clockwise direction, and rotate the motor torque output member in a counterclockwise direction.

24. The system of claim 13 wherein at least one of the first and second cable drive actuators further includes a gear mechanism having an input connected to a motor torque output member and a rotatable output shaft connected to the cable spool, said gear mechanism adapted to reduce the rotational speed of the rotatable output shaft of the gear mechanism to less than a rotational speed of the motor torque output and increase the torque output in the rotatable output shaft of the gear mechanism.

25. A method for positioning a heliostat mirror, said system comprising:
providing a heliostat mirror, said heliostat mirror pivotally mounted on a heliostat mirror support structure;
providing a first cable drive actuator having a first motor, driving a first cable spool, and a first cable attached at a proximal end to the first cable spool and attached at a distal end to a rear side of the heliostat mirror;
providing a second cable drive actuator having a second motor driving a second cable spool, and a second cable attached at a proximal end to the second cable spool and attached at a distal end to the heliostat mirror;
providing a pivot mechanism adapted to pivot the heliostat mirror about a first generally horizontal axis and about a second axis generally perpendicular to the first axis, said pivot mechanism attached to a rear side of the heliostat mirror and attached to the heliostat mirror support structure;
providing a controller operatively connected to the first cable drive actuator and to the second cable drive actuator;
sending a signal directing the first cable drive actuator to spool in the first cable to pivot about the first axis and about the second axis toward the first cable drive actuator a predetermined amount.

26. The method of claim 25 further including sending a signal directing the second cable drive actuator to let out the second cable to allow the heliostat mirror to pivot toward the first cable drive actuator about the second axis.

27. The method of claim 25 further including sending a signal to the second cable drive actuator to spool in the second cable to allow the heliostat mirror to pivot toward the first cable drive actuator about the first axis.

28. The method of claim 25 further including:
providing a third cable drive actuator mounted on the support structure, said third cable drive actuator having a third motor, driving a third cable spool, and a third cable attached at a proximal end to the third cable spool and attached at a distal end to the rear side of the heliostat mirror;
providing a first tension line sensor on the first cable operatively connected to the controller, and a second tension line sensor on the second cable operatively connected to the controller;
receiving in the controller tension information from the first and second tension line sensors;
providing instructions to the third cable drive actuator to either let out the third cable or to spool in the third cable to adjust the tension in the first and second cables attached to the first and second cable drive actuators.

29. The method of claim 25 further including sending a signal from the controller to at least one of the first and second motors of the first and second cable drive actuators to stop, start, rotate a motor torque output member of the first motor in a clockwise direction, and rotate the motor torque output member of the second motor in a counterclockwise direction.

30. A method for positioning a solar panel, said system comprising:
providing a solar panel, said solar panel pivotally mounted on a solar panel support structure;
providing a first cable drive actuator having a first motor, driving a first cable spool, and a first cable attached at a proximal end to the first cable spool and attached at a distal end to the solar panel;
providing a second cable drive actuator having a second motor driving a second cable spool, and a second cable attached at a proximal end to the second cable spool and attached at a distal end to the rear side of the solar panel;
providing a pivot mechanism adapted to pivot the solar panel about a first generally horizontal axis and about a second axis generally perpendicular to the first axis, said pivot mechanism attached to the rear side of the solar panel and attached to the solar panel support structure;
providing a controller operatively connected to the first cable drive actuator and to the second cable drive actuator;
sending a signal directing the first cable drive actuator to spool in the first cable to pivot about the first axis and about the second axis toward the first cable drive actuator a predetermined amount.

31. The method of claim 30 further including sending a signal directing the second cable drive actuator to let out the second cable to allow the heliostat mirror to pivot toward the first cable drive actuator about the second axis.

32. The method of claim 30 further including sending a signal to the second cable drive actuator to spool in the second cable to allow the heliostat mirror to pivot toward the first cable drive actuator about the first axis.

33. The method of claim 30 further including:
providing a third cable drive actuator mounted on the support structure, said third cable drive actuator having a third motor, driving a third cable spool, and a third cable attached at a proximal end to the third cable spool and attached at a distal end to the solar panel;
providing a first tension line sensor on the first cable operatively connected to the controller, and a second tension line sensor on the second cable operatively connected to the controller;
receiving in the controller tension information from the first and second tension line sensors;
providing instructions to the third cable drive actuator to either let out the third cable or to spool in the third cable to adjust the tension in the first and second cables attached to the first and second cable drive actuators.

34. The method of claim 30 further including sending a signal from the controller to at least one of the first and second motors of the first and second cable drive actuators to stop, start, rotate a motor torque output member of the first motor in a clockwise direction, and rotate the motor torque output member of the second motor in a counterclockwise direction.

35. A system for positioning a heliostat mirror, said system comprising:
a heliostat mirror;
a heliostat mirror support structure;
a pivot mechanism adapted to pivot the heliostat mirror about a first generally horizontal axis and about a second axis generally perpendicular to the first axis, said pivot mechanism attached to a rear side of the heliostat mirror and attached to the heliostat mirror support structure;
a first cable drive actuator mounted on the heliostat mirror, said first cable drive actuator having a first motor driving a first cable spool, and a first cable attached at a proximal end to the first cable spool and a distal end of the first cable attached to the heliostat mirror support structure; and
a second cable drive actuator mounted on the heliostat mirror, said heliostat mirror having a second motor driving a second cable spool, and a second cable attached at a proximal end to the second cable spool and a distal end of the second cable attached to the heliostat mirror support structure.

36. The system of claim 35 further including a controller operatively connected to the first cable drive actuator, said controller adapted to direct the first cable drive actuator to spool in the first cable to pivot the heliostat mirror about the second axis a predetermined amount, and said controller operatively connected to the second cable drive actuator and adapted to direct the second cable drive actuator to let out the second cable to allow the heliostat mirror to pivot about the second axis.

37. The system of claim 35 further including a controller operatively connected to the first cable drive actuator, said controller adapted to direct the first cable drive actuator to spool in the first cable to pivot the heliostat mirror about the first axis a predetermined amount, and operatively connected to the second cable drive actuator and adapted to direct the second cable drive actuator to spool in the second cable to allow the heliostat mirror to pivot about the first axis.

38. The system of claim 35 further including a controller operatively connected to the first cable drive actuator, said controller adapted to direct the first cable drive actuator to spool in the first cable to pivot the heliostat mirror about the first axis and about the second axis a predetermined amount.

39. A system for positioning a solar panel, said system comprising:
a solar panel;
a solar panel support structure;
a pivot mechanism adapted to pivot the solar panel mirror about a first generally horizontal axis and about a second axis generally perpendicular to the first axis, said pivot mechanism attached to a rear side of the solar panel and attached to the solar panel support structure;
a first cable drive actuator mounted on the solar panel, said first cable drive actuator having a first motor driving a first cable spool, and a first cable attached at a proximal end to the first cable spool and distal end of the first cable attached to the solar panel support structure; and
a second cable drive actuator mounted on a heliostat mirror, said solar panel having a second motor driving a second cable spool, and a second cable attached at a proximal end to the second cable spool and a distal end of the second cable attached to the solar panel support structure.

40. The system of claim 39 further including a controller operatively connected to the first cable drive actuator, said controller adapted to direct the first cable drive actuator to spool in the first cable to pivot the solar panel about the second axis a predetermined amount, and said controller operatively connected to the second cable drive actuator and adapted to direct the second cable drive actuator to let out the second cable to allow the solar panel to pivot about the second axis.

41. The system of claim 39 further including a controller operatively connected to the first cable drive actuator, said controller adapted to direct the first cable drive actuator to spool in the first cable to pivot the solar panel about the first axis a predetermined amount, and operatively connected to the second cable drive actuator and adapted to direct the second cable drive actuator to spool in the second cable to allow the solar panel mirror to pivot about the first axis.

42. The system of claim 39 further including a controller operatively connected to the first cable drive actuator, said controller adapted to direct the first cable drive actuator to spool in the first cable to pivot the solar panel about the first axis and to pivot the solar panel about the second axis a predetermined amount.
